(19) United States
(12) Patent Application Publication
(10) Pub. No.: US 2012/0287953 A1
(43) Pub. Date: Nov. 15, 2012

(54) LASER DEVICE

(75) Inventors: Yasutoshi TAKADA, Kawasaki-shi (JP); Yoshiro Tani, Mito-shi (JP)

(73) Assignee: NIKON CORPORATION, Tokyo (JP)

(21) Appl. No.: 13/554,664

(22) Filed: Jul. 20, 2012

Related U.S. Application Data
(63) Continuation of application No. 12/977,833, filed on Dec. 23, 2010, now abandoned.

(30) Foreign Application Priority Data
Jan. 6, 2010 (JP) 2010-001509

(51) Int. Cl. H01S 3/13

(52) U.S. Cl. 372/29.02; 372/29.02

(57) ABSTRACT

A laser device includes a partially reflective mirror for separating laser light into monitor light and output light, a light output monitor device for detecting the intensity of the monitor light from the partially reflective mirror, a controller for controlling the intensity of the output light from the partially reflective mirror by controlling the output of a laser light source on the basis of a detection value of the light output monitor device, and a power meter device for detecting the intensity of the output light from the partially reflective mirror during a predetermined calibration time period, wherein the controller calibrates the output of the light output monitor device on the basis of a detection value of the power meter device.

### INCORPORATION BY REFERENCE

This is a continuation of application Ser. No. 12/977,833 filed Dec. 23, 2010 and claims the benefit of Japanese Patent Application No. 2010-001509 filed Jan. 6, 2010. The entire disclosures of the prior applications are hereby incorporated by reference herein in their entirety.

### BACKGROUND

The present invention relates to a laser device having the functions of monitoring light output and controlling light output at a constant in accordance with the monitoring results.

Laser devices such as the one described above are used as light sources of exposure devices for forming microscopic structures on semiconductor devices, various optical inspection devices for observing microscopic structures, laser therapy devices used in ophthalmologic therapy and the like, and other devices, for example. In one example of a known configuration, laser light of an infrared wavelength generated by a semiconductor laser and amplified by a optical amplifier undergoes sequential wavelength conversion in a wavelength conversion device comprising a plurality of wavelength conversion elements, and the resulting light is ultimately generated as ultraviolet light having a wavelength λ of 193 nm, which is the same as the oscillation wavelength of an ArF excimer laser (refer to Japanese Laid-open Patent Publication No. 2000-200747, for example).

To stabilize the light output of the laser light in a laser device, various means have been proposed in which the light output of the laser light is detected by a light output monitor device (commonly a photodiode or other photodetectors), and the drive current applied to the semiconductor laser undergoes feedback control while the light output is monitored so that the desired light output is obtained (APC: automatic power control: refer to Japanese Laid-open Patent Publication No. 2002-42362, for example).

### SUMMARY

However, in a conventional configuration, when deep-ultraviolet light or high-output laser light is operated over a long period of time, the light output monitoring device deteriorates due to damage, the detection sensitivity decreases, and the light output can no longer be accurately detected by the light output monitoring device. Therefore, a problem arises in that the light output undergoing feedback control as described above deviates greatly from the appropriate set value, and the light output can no longer be controlled at a constant.

The present invention was developed in view of such problems, it being an object thereof to provide a laser device having a configuration whereby light output can be accurately controlled and stable operation over a long period of time is possible.

The laser device of the present invention comprises a laser light output unit for emitting a laser light, a light separator for separating the laser light from the laser light output unit into a monitor light and an output light, a light output monitor for detecting the power of the monitor light from the light separator, a light output controller for controlling the power level of the output light from the light separator by controlling the output of the laser light output unit on the basis of a detection value of the light output monitor, and a light power detector for detecting the power level of the output light from the light separator during a predetermined calibration time period; the light output controller calibrating the output of the light output monitor on the basis of a detection value of the light power detector.

In the configuration described above, a laser head preferably has a laser light generator for generating a fundamental-wave laser light, and a wavelength converter for converting the wavelength of the fundamental-wave laser light from the laser light generator and emitting a resulting light to the light separator as a laser light containing predetermined harmonic wave. It is also a preferred aspect of the present invention that the predetermined harmonic wave is deep-ultraviolet light having a wavelength of 200 nm or less. Furthermore, it is a preferred aspect that the laser device further comprises a light extractor for extracting only the predetermined harmonic wave laser light from the laser light output from the wavelength converter and emitting the predetermined harmonic wave laser light to the light separator.

In the configuration described above, it is preferred that the laser light irradiated position of at least one of the light separator and the light extractor is to be shifted by a predetermined amount with time intervals set in advance. Furthermore, it is a preferred aspect that the laser device further comprises a shift mechanism for shifting the light separator and the light extractor as an integrated unit in a predetermined amount. It is also a preferred aspect that at least one of the light separator, the light output monitor, the light power detector, the light extractor, and the shift mechanism is to be housed within a casing having an entrance port into which the laser light from the laser light output unit is led and an exit port out from which output the light is directed, and the casing can be replaced as a single unit in the laser device.

Through the present invention, even when the detection sensitivity of the light output monitor fluctuates due to deterioration or the like, the output of the light output monitor is calibrated by the controller on the basis of the absolute value of the light output detected by the light power detector, and long-term stable operation can therefore be achieved by accurately controlling the light output.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only and thus are not limitative of the present invention.

FIG. 1 is a schematic structural view of a laser device, shown as an applied example of the present invention;

FIG. 2 is a schematic structural view of a laser head in the laser device;

FIG. 3 is a schematic structural view of a wavelength converter in the laser device;

FIG. 4 is a schematic structural view of a power control unit in the laser device; and

FIG. 5 is a schematic structural view showing a modification of the power control unit.

### DETAILED DESCRIPTION OF EMBODIMENTS

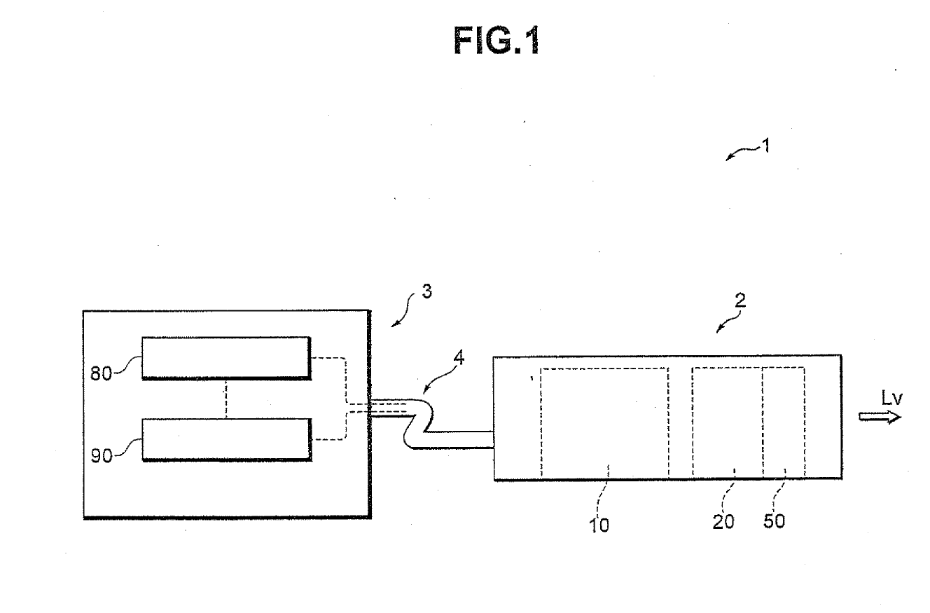

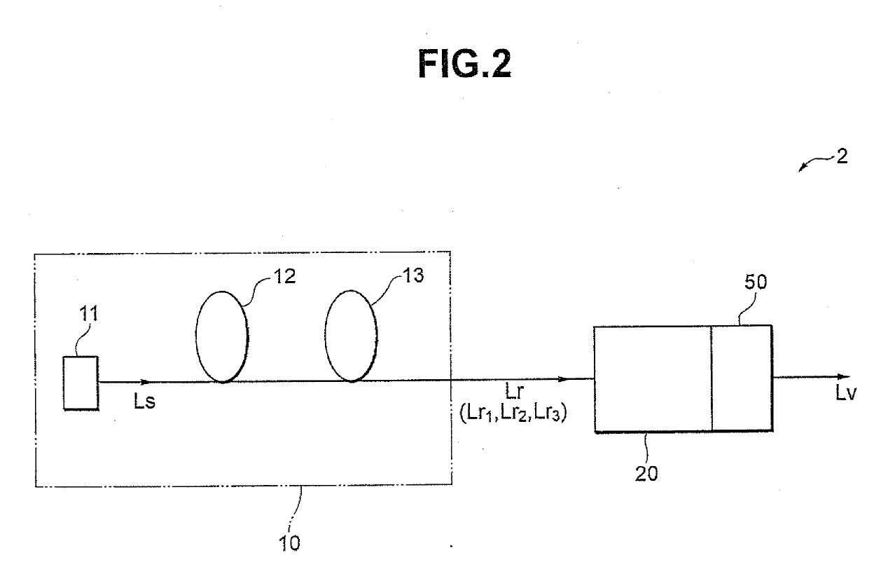

Embodiments for carrying out the present invention are described hereinbelow with reference to the drawings. As a typical example of a laser device to which the present invention is applied, FIG. 1 shows the schematic structure of a laser device 1 used as a light source device of an exposure device for exposing a reticle pattern onto a substrate, FIG. 2 shows the schematic structure of a laser head 2 in this laser device 1, and a summary of the laser device 1 will first be described while referring to these drawings.

For the sake of convenience in applying the laser device 1 to a laser system used as a light source device, the laser device 1 is composed of the small, box-shaped laser head 2 which has an output function for emitting a deep-ultraviolet light and which has a simplified manner of being incorporated into a laser system, and a case-shaped control rack 3 having a function for controlling the laser head 2 and placed separate from the laser head 2. The laser head 2 and the control rack 3 are connected to each other by an interface 4, which comprises various electrical cables, an optical fiber for excited light transmission, a gas tube for supplying purge gas, a cold water supply tube, or the like.

The laser head 2 comprises a laser light generator 10 for emitting a fundamental laser light in the infrared to visible range of wavelength, and a wavelength converter 20 for converting the fundamental laser light emitted from the laser light generator 10 to a deep-ultraviolet light by wavelength conversion, wherein the laser head 2 is configured so that the deep-ultraviolet light is output from an output end thereof.

The laser light generator 10 is configured comprising a laser light source 11 for generating laser light (seed light) Ls, and optical amplifiers 12, 13 for amplifying the laser light Ls generated from the laser light source 11. The laser light source 11 and the optical amplifiers 12, 13 have suitable oscillation wavelengths and amplification factors in accordance with the application and function of the laser system that uses the laser device 1. In the configuration exemplified here, a distribution feedback semiconductor laser (DFB semiconductor laser) which generates laser light having a single wavelength λ of 1.547 [μm] is used as this type of laser light source 11, an erbium (Er)-doped optical fiber amplifier (EDFA) excited by a semiconductor laser is used as the first optical amplifier 12, and an EDFA excited by a Raman laser is used as the second optical amplifier 13. The output from the laser light generator 10 is controlled by the excitation light supplied to the optical amplifier 13 output from the Raman laser.

The wavelength converter 20 converts the laser light (fundamental wave light amplified by the optical amplifiers 12, 13) Lr emitted from the laser light generator 10 to the deep-ultraviolet light which has a predetermined wavelength by wavelength conversion. In the laser device 1, fundamental wave laser light having a wavelength λ of 1.547 [μm] emitted from the laser light generator 10 is sequentially undergoes wavelength conversion by a plurality of wavelength conversion optical elements, and deep-ultraviolet light of an octuple wave (eighth harmonic wave) of the fundamental wave which has a wavelength λ of 193 [nm], the same wavelength as an ArF excimer laser, is ultimately output.

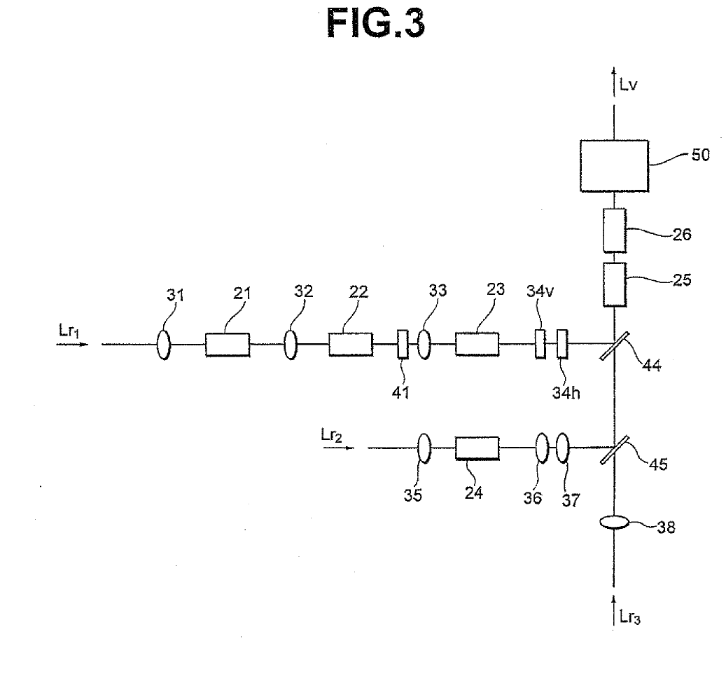

There are various conventional embodiments of a configuration (type or combination of wavelength conversion optical elements) of a wavelength converter for converting the fundamental wave laser light Lr in the infrared wavelength range (or the visible wavelength range) to the deep-ultraviolet light. As an example of a wavelength converter in the present embodiment, FIG. 3 shows a configuration of the laser light generator 10 wherein fundamental laser light emitted from one laser light source is devided into three beams which are all amplified by the two optical amplifiers 12, 13, the three beams of amplified fundamental laser light Lr (Lr₁, Lr₂, Lr₃) are directed to the wavelength converter 20; fundamental wave, second harmonic wave (λ=774 [nm]), and fifth harmonic wave (λ=309 [nm]) are generated, and from the sum frequency generation of these waves, seventh harmonic wave (λ=221 [nm]) and eighth harmonic wave (λ=193 [nm]) are generated. A summary of the configuration of this wavelength converter 20 is described below refer to FIG. 3.

An incident first fundamental wave laser light Lr₁ in a form of P-polarized light is collected and directed by a lens 31 onto a wavelength conversion optical element 21, and a second harmonic wave whose frequency is twice (2ω) and wavelength is half of those of the fundamental wave of frequency (ω) and wavelength λ is generated by second harmonic generation (SHG). The second harmonic wave in a form of P-polarized light generated by the wavelength conversion optical element 21 and the fundamental wave in a form of P-polarized light transmitted through the wavelength conversion optical element 21 are collected and directed by a lens 32 onto a wavelength conversion optical element 22, and a third harmonic wave whose frequency is three times (3ω) of the fundamental wave is generated by sum harmonic generation (ω+2ω). For these wavelength conversion optical elements 21, 22, a PPLN crystal is used as the wavelength conversion optical element 21 for second harmonic wave generation, and an LBO crystal is used as the wavelength conversion optical element 22 for third harmonic wave generation, for example. A PPKTP crystal, a PPSLT crystal, and LBO crystal, or the like can also be used as the wavelength conversion optical element 21.

The third harmonic wave in a form of S-polarized light generated by the wavelength conversion optical element 22 and the fundamental wave and the second harmonic wave in a form of P-polarized light transmitted through the wavelength conversion optical element 22 are then transmitted through a two-wavelength wave plate 41, and only the second harmonic wave is converted to S-polarized light. A wave plate composed of a flat plate of uniaxial crystal cut to be parallel with the optical axis of the crystal, for example, is used as the two-wavelength wave plate 41. This wave plate 41 is configured by being cut so that the thickness of the wavelength plate (the crystal) is an integral multiple of λ/2 relative to one light (second harmonic wave) of a wavelength λ for rotating its S-polarized light and is also an integral multiple of λ relative to another light of a wavelength λ for not rotating its polarized light.

The second harmonic wave and third harmonic wave, after both of them became S-polarized light are collected and directed by a lens 33 onto a wavelength conversion optical element 23, and a fifth harmonic wave (5ω) is generated by sum harmonic generation (2ω+3ω). The fifth harmonic wave in a form of P-polarized light generated by the wavelength conversion optical element 23, the second harmonic wave and the third harmonic wave in a form of S-polarized light transmitted through the wavelength conversion optical element 23, and fundamental wave in a form of P-polarized light are emitted from the wavelength conversion optical element 23. An LBO crystal, for example, is used as the wavelength conversion optical element 23 for generating the fifth harmonic wave, and a BBO crystal and a CBO crystal can also be used. The fifth harmonic wave emitted from the wavelength conversion optical element 23 have an elliptical cross section by walk-off. The elliptical cross-sectional shape is shaped to a circle by two cylindrical lenses 34v, 34h, and the wave is directed onto a dichroic mirror 44.

An incident second fundamental wave laser light Lr₂ in a form of P-polarized light is collected and directed by a lens 35 onto a wavelength conversion optical element 24, and a second harmonic wave is generated by second harmonic generation. The second harmonic wave and the fundamental wave both in a form of P-polarized light generated by the wavelength conversion optical element 24 are emitted from the wavelength conversion optical element 24 and directed onto a dichroic mirror 45 via lenses 36, 37. A PPLN crystal can be used as the wavelength conversion optical element 24, or a PPKTP crystal, a PPSLT crystal, an LBO crystal, or the like may also be used.

An incident third fundamental wave laser light Lr₃ in a form of S-polarized light is directed via a lens 38 onto the dichroic mirror 45. The dichroic mirror 45 is configured so as to transmit light in a wavelength range of the fundamental wave and reflect light in the wavelength range of the second harmonic wave. The fundamental wave in a form of S-polarized light entered into the dichroic mirror 45 and the second harmonic wave in a form of P-polarized light generated by the wavelength conversion optical element 24 are combined into the same axis.

After combining the fundamental wave in a form of S-polarized light and the second harmonic wave in a form of P-polarized light are directed onto the dichroic minor 44. The dichroic minor 44 is configured so as to transmit light in a wavelength range of the fundamental wave and the second harmonic wave and reflect light in a wavelength range of the fifth harmonic wave, and the fundamental wave in a form of S-polarized light and the second harmonic wave in a form of P-polarized light entered into the dichroic mirror 44 are combined into the same axis with the fifth harmonic wave in a form of P-polarized light generated by the wavelength conversion optical element 23.

The fundamental wave in a form of S-polarized light, the second harmonic wave in a form of P-polarized light, and the fifth harmonic wave in a form of P-polarized light combined into the same axis in this manner are directed onto a wavelength conversion optical element 25. The lenses (34v, 34h, 36, 37, 38) are provided in the respective optical paths of the fundamental wave, the second harmonic wave, and the fifth harmonic wave, and the light of all these wavelengths combined along the same axis is collected and directed onto the wavelength conversion optical element 25. In the wavelength conversion optical element 25, sum harmonic generation (2ω+5ω) is performed on the second harmonic wave in a form of P-polarized light and the fifth harmonic wave in a form of P-polarized light, and seventh harmonic wave (7ω) is generated. The seventh harmonic wave in a form of S-polarized light generated by the wavelength conversion optical element 25 and the light of all the different wavelengths transmitted through the wavelength conversion optical element 25 are emitted from the wavelength conversion optical element 25. A CLBO crystal, for example, is used as the wavelength conversion optical element 25 for generating seventh harmonic wave.

These light beams are directed onto a wavelength conversion optical element 26 where fundamental wave in a form of S-polarized light and seventh harmonic wave in a form of S-polarized light are combined by sum harmonic generation (ω+7ω), and eighth harmonic wave (8ω) in a form of P-polarized light is generated. A CLBO crystal, for example, is used as the wavelength conversion optical element 26 for generating the eighth harmonic wave. The eighth harmonic wave generated by this wavelength conversion optical element 26 and the light of all the wavelengths transmitted through the wavelength conversion optical element 26 are then emitted from the wavelength conversion optical element 26 and directed onto a power control unit 50 disposed in their optical path.

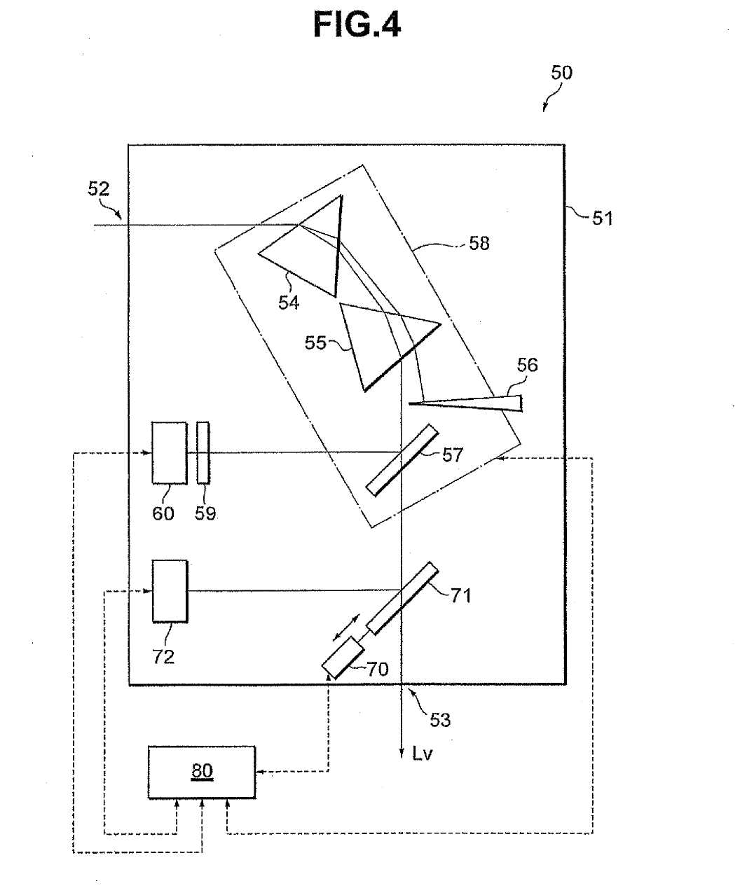

The configuration of the power control unit 50 is described with reference to FIG. 4. The power control unit 50 is configured comprising a unit case 51, dispersing prisms 54, 55, a light absorber 56, a partial reflection mirror 57, a shift mechanism 58, a neutral density filter 59, a light output monitor device 60, a drive mechanism 70, a total reflection mirror 71, and a power meter device 72, as shown in FIG. 4, and the power control unit 50 are set up as being aligned on a base plate (not shown) serving as the base of the unit. This power control unit 50 is configured to be capable of being removed (replaced) as a single unit from the laser head 2.

The unit case 51 on the whole has a rectangular box shape, and has an entrance port 52 into which a laser light emitted from the wavelength conversion optical element 26 is led into the interior, and an exit port 53 out from which eighth harmonic wave deep-ultraviolet laser light Lv is directed to the exterior. The laser light led in from the entrance port 52 of the unit case 51 is directed to the dispersing prisms 54, 55.

Aside from eighth harmonic wave generated by the wavelength conversion optical element 26, the light beams of the fundamental wave, the second harmonic wave, and other wavelength components transmitted through the wavelength conversion optical element 26 are also directed onto the dispersing prisms 54, 55, and since the eighth harmonic wave is refracted more than the light of the other wavelength components in the dispersing prisms 54, 55 (since smaller wavelengths have greater refractive indexes by the dispersing prisms 54, 55), the eighth harmonic wave can be separated from the light of the other wavelength components. In the present embodiment, a case is presented in which the two dispersing prisms 54, 55 are disposed in order to bend the eighth harmonic wave at about 90 degrees, however the configuration is not limited to this option, and one, three, or more dispersing prisms may be disposed.

The light of other wavelength components besides eighth harmonic wave divided by the dispersing prisms 54, 55 are directed to the light absorber 56 composed of silicon with nano chips or the like, for example, and are absorbed by multiple reflection in the light Absorber 56. The eighth harmonic wave separated in the dispersing prisms 54, 55 is directed to the partial reflection mirror 57.

The partial reflection mirror 57 is a reflective mirror for partially extracting some part of the incident eighth harmonic wave as a monitor light (faint light for monitoring). The dispersing prisms 54, 55 and the partial reflection mirror 57 are attached to a base plate via the shift mechanism 58. The shift mechanism 58 is comprised of a micro-driving stage or the like capable of moving in one axial direction orthogonal to the optical axis (e.g., the direction orthogonal to the image plane of FIG. 4). Based on a stage drive signal output from a controller 80 of the control rack 3, described hereinafter, the shift mechanism 58 shifts the dispersing prisms 54, 55 and the partial reflection mirror 57 a predetermined amount at time intervals set in advance and changes the received position of laser light. A value of the predetermined amount of shift is approximately the same as the beam diameter for example.

The partial reflection mirror 57 reflects some part of the eighth harmonic wave (e.g., 1% of the light or less) as monitor light, depending on the reflectivity of the mirror, and leads the monitor light to the light output monitor device 60 via the neutral density filter 59 for adjusting power of the monitor light. Possible examples of the partial reflection mirror 57 include a mirror which has low reflectivity due to the direction of incident light polarization being that of P-polarization without any coating, or a mirror which has a low-reflectivity coating applied.

The neutral density filter 59 is included in view of the fact that the photo diode commonly applied to the light output monitor device 60 is capable of detecting only faint light.

The light output monitor device 60 comprises a photo diode or other detecting elements, for example, the light output monitor device 60 receives some part of the eighth harmonic wave (monitor light) sent from the partial reflection mirror 57 and converts the waves to an electric current signal corresponding to an amount of received light (power of the monitor light). This electric current signal is converted to a voltage signal by an amplifier circuit (not shown) installed in the light output monitor device 60, and the voltage signal is amplified with a gain that can be set as desired and is output to the controller 80 of the control rack 3.

The control rack 3 is provided with the controller 80 for collectively controlling the actions to the components making up the laser device 1 and controlling the output of the UV/laser light Lv from the laser head 2, a gas supply unit 90 for supplying N₂ gas or other inert gas to the power control unit 50 and other components of the laser device 1 via a gas tube (not shown) running through the interface 4, an excitation light source (not shown) for exciting the optical amplifiers 12, 13, and other components.

The controller 80 is configured having a so-called microcomputer composed of a CPU (central processing unit), a ROM (read-only memory), a RAM (random access memory), and other components, for example. Based on the voltage signal sent from the light output monitor device 60, the controller 80 conducts a feedback control to the excitation light output supplied to the optical amplifier 13 so that the voltage value coincides with a control command value set in advance (i.e., so that the laser light output is constant).

On this point, although the photo diode given as the typical example of the light output monitor device 60 has the characteristics of being more sensitive and having faster response than a thermopile or other thermoelectric converter type detector, there is a risk that when the photo diode is exposed for a long period of time to the deep ultraviolet laser light Lv as the eighth harmonic wave, the photodiode might be easily damaged and its detection sensitivity might fluctuate. As a result, there is a problem in that it might be possible not to supply the proper excitation light output for feedback control to the optical amplifier 13 and not to control the light output at a constant. In view of this, in the present embodiment, the drive mechanism 70, the total reflection mirror 71, and the power meter device 72 are provided in the unit case 51, and the controller 80 has a function for calibrating the output (output voltage value) of the light output monitor device 60.

The deep-ultraviolet laser light Lv transmitted through the partial reflection mirror 57 is emitted to the exterior as the output light of the laser device 1 from the exit port 53 of the unit case 51. The total reflection mirror 71 is provided in the optical path between the partial reflection mirror 57 and the exit port 53, the total reflection mirror 71 being capable of being moved back and forth relative to the optical path by an electromagnetic solenoid or other drive mechanism 70. Based on a drive control signal output from the controller 80, the drive mechanism 70 retracts the total reflection mirror 71 from the optical path when the ultraviolet laser light Lv is emitted to the exterior, and places the total reflection mirror 71 in the optical path for a short time (e.g., a time corresponding to the response speed of the power meter device 72) at predetermined time intervals (e.g., every 24 hours) set in advance when the output of the light output monitor device 60 is calibrated. When the total reflection mirror 71 is placed in the optical path, the ultraviolet laser light Lv directed to the exit port 53 is reflected by the total reflection mirror 71 so as to bend approximately 90 degrees and is led into the thermoelectric converter type power meter device 72.

The power meter device 72, unlike the photo diode previously described, is light output detection means for detecting the light output (power) of the laser light by measuring temperature (thermal energy), and is capable of detecting the absolute value of the power of the deep-ultraviolet laser light Lv. A thermopile or the like is given as an example of the power meter device 72. This thermopile commonly has a structure in which a plurality of thermocouples are connected in series, and a hot junction is arranged in the laser light irradiated surface, while a cold junction thermally insulated from the hot junction is provided for measuring the surrounding temperature. The power meter device 72 outputs to the controller 80 an electromotive force (a voltage signal) according to an absorption of heat energy (a temperature difference between the hot junction and the cold junction) by irradiating the laser light.

The controller 80 adjusts a gain and an offset value of the light output monitor device 60 on the basis of a light output signal measured by the power meter device 72. More specifically, in the initial state before the deep-ultraviolet laser light Lv is output to the exterior from the laser device 1, an accurate correlation (conversion factor) between the output voltage value of the light output monitor device 60 and the light output value of the power meter device 72 is calculated, whereby the gain and the offset value for converting the output voltage value of the light output monitor 1 device 60 to a light output value are calibrated so as to achieve a light output value of the light output monitor device 60 corresponds to the light output value of the power meter device 72 in accordance with the aforementioned correlation. For example, when the light output value of the power meter device 72 is the same as the initial value thereof whereas the light output value of the light output monitor device 60 is half of the initial value thereof, the conversion gain value (of the amplification circuit of the photo diode) of the light output monitor device 60 is to adjusted double. Moreover, when no light is coming to the light output monitor device 60 the offset value of the light output monitor device 60 is to adjusted so as not to be zero based on the aforementioned correlation. The light output value of the light output monitor device 60 is thereby properly calibrated.

Based on the calibrated voltage signal sent from the light output monitor device 60, the controller 80 accurately controls the feedback of the excitation light output supplied to the optical amplifier 13 and controls the output of deep-ultraviolet laser light Lv at a constant.

Thus, in the laser device 1, even in eases in which the light output monitor device (photo diode) 60 is exposed to the deep-ultraviolet laser light Lv over a long period of time and its detection sensitivity fluctuations due to deterioration or the like, or its reflectivity fluctuations of the partial reflection mirror 57 due to deterioration, the output of the light output monitor device 60 is accurately calibrated based on the detection value of the power meter device 72 for detecting the absolute value of the light output with a predetermined timing. Accordingly, the proper excitation light output can be supplied as feedback control to the optical amplifier 13 and the light output of the laser device 1 can be stabilized. Therefore, the laser device 1 described above can achieve a long-term stable operation by accurate controlling of the light output.

There is also a risk that the dispersing prisms 54, 55 or the partial reflection mirror 57 will also be damaged and degraded by exposure to eighth harmonic wave (the deep-ultraviolet light). However, since the dispersing prisms 54, 55 and the partial reflection mirror 57 are shifted at fixed time intervals by the shift mechanism 58 and the eighth harmonic wave irradiated position is Changed (eighth harmonic wave is received in an unused area) as described above, a life of these elements can be extended, and it is possible to prevent deterioration of light output or beam quality caused by deterioration from damage.

Furthermore, since the dispersing prisms 54, 55 and the partial reflection mirror 57 are mounted together on the shift mechanism 58 and shifted as a whole, fluctuation in their relative positions can be prevented, and efficient operation can be achieved.

When the actual usage time of the light output monitor device 60, the partial reflection mirror 57, or other component has passed a predetermined stipulated time and the component needs to be replaced, since the components of the power control unit 50 are all housed within the unit case 51 and can be easily replaced as single units, laser light can again be implemented within a short time following the replacement, and the time for starting up the laser device 1 after replacement of the power control unit 50 can be reduced.

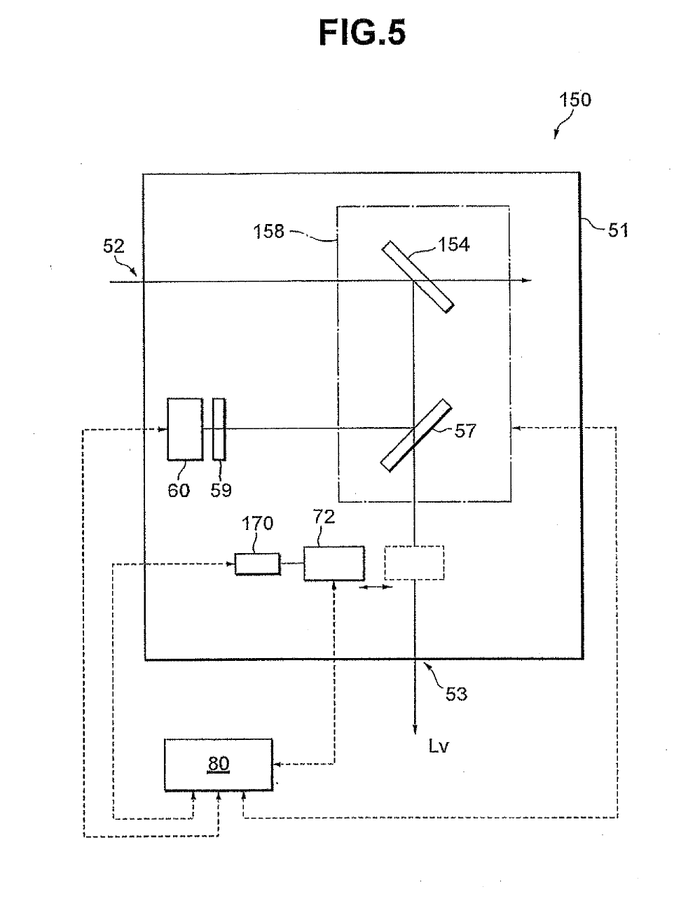

The preferred embodiment of the present invention has heretofore been described, but the present invention is not limited to this embodiment. For example, as a modification of the power control unit, a wavelength-selective mirror 154 may be provided instead of the dispersing prisms (the dispersing prisms 54, 55 in the embodiment described above) as a light extractor for extracting only eighth harmonic wave from the light of plurality of wavelength incident on a power control unit 150, as shown in FIG. 5. The example given for this wavelength-selective mirror 154 is a total reflection mirror (having a reflectivity of approximately 100%) of the eighth harmonic wave as a final output wavelength with a predetermined coating which fully transmit (has a transmittance of approximately 100% for) a light of wavelength other than that of the eighth harmonic wave.

Similarly, as shown in FIG. 5, it is possible to structure the power meter device 72 itself between the partial reflection mirror 57 and the exit port 53 being capable of being moved back and forth relative to the optical path by an electromagnetic solenoid or other drive mechanism 170 without providing a total reflection mirror (the total reflection mirror 71 in the embodiment described above), for example.

In the embodiment described above, an example was given in which the dispersing prisms 54, 55, the light absorber 56, the partial reflection mirror 57, the shift mechanism 58, the neutral density filter 59, the light output monitor device 60, the drive mechanism 70, the total reflection mirror 71, the power meter device 72, and other components are all housed within the unit case 51 and the power control unit 50 is configured as a single unit, however the present invention is not limited to this configuration and some of these components may be configured as their own single unit. Such a configuration is reasonable in cases in which the replacement interval (lifetime) differs for each element.

In the embodiment described above, an example of a configuration for the laser light generator 10 was given in which the laser light (seed light) Ls generated by the laser light source 11 is amplified by the two optical amplifiers 12, 13 connected in series and the amplified laser light Lr is directed to the wavelength converter 20, however other configurations may be used. According to the output or amplification factor of the laser light source 11, one, three, or more optical amplifiers may be provided or light emitted from the laser light source 11 may be led directly to the wavelength converter 20 without passing through any optical amplifier; or, according to the configuration of the wavelength converter 20, a single row of optical amplifiers may be used instead of dividing the laser light emitted from the laser light source 11 into a plurality of beams and amplifying the beams by a plurality of optical amplifiers arranged in parallel. Though not described for the sake of simplifying the description, EONS or other light modulators for cutting out light pulses, narrow bandpass filters for increasing monochromatic light, or the like are suitably provided between the laser light source 11 and the optical amplifier 12 and also between the optical amplifier 12 and the wavelength converter 20.

The wavelength of the light output from the laser device 1 is not limited to 193 nm; the wavelength band may be the same as that of a KrF excimer laser, an F2 laser, or the like. Furthermore, the applied example of the laser device according to the present invention is not limited to an exposure device; the laser device can be used in various optical inspection devices, laser therapy devices, and other various types of devices.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A laser device comprising:
a laser light output unit for outputting laser light;
a light separator for separating the laser light from the laser light output unit into monitor light and output light;
a light output monitor for detecting the intensity of the monitor light from the light separator;
a light output controller for controlling the intensity of the output light from the light separator by controlling the output of the laser light output unit on the basis of a detection value of the light output monitor; and
a light intensity detector for detecting the intensity of the output light from the light separator during a predetermined calibration time period;
the light output controller calibrating the output of the light output monitor on the basis of a detection value of the light intensity detector.

2. The laser device according to claim 1, wherein the laser light output unit is configured having a laser light generator for generating fundamental-wave laser light, and a wavelength converter for converting the wavelength of the fundamental-wave laser light from the laser light generator and outputting the resulting light to the light separator as laser light containing predetermined harmonic waves.

3. The laser device according to claim 2, wherein the predetermined harmonic waves are deep-ultraviolet light having a wavelength of 200 nm or less.

4. The laser device according to claim 2, further comprising a light extractor for extracting the predetermined harmonic-wave laser light alone from the laser light outputted from the wavelength converter and outputting the harmonic-wave laser light to the light separator.

5. The laser device according to claim 4, wherein the laser light receiving position of at least one of the light separator and the light extractor is shifted by a predetermined amount at time intervals set in advance.

6. The laser device according to claim 5, further comprising a shift mechanism for shifting the light separator and the light extractor as an integrated unit by a predetermined amount.

7. The laser device according to claim 6, wherein at least one of the light separator, the light output monitor, the light intensity detector, the light extractor, and the shift mechanism is housed within a casing having an entrance port into which laser light from the laser light output unit is led and an exit port out from which output light is directed, and the casing can be replaced as a single unit in the laser device.

8. The laser device according to claim 3, further comprising a light extractor for extracting the predetermined harmonic-wave laser light alone from the laser light outputted from the wavelength converter and outputting the harmonic-wave laser light to the light separator.
